(19) United States
(12) Patent Application Publication
(10) Pub. No.: US 2016/0015208 A1
(43) Pub. Date: Jan. 21, 2016

(54) COOKWARE INCLUDING LID HAVING HANDLE WITH UTENSIL REST

(71) Applicant: Dart Industries Inc., Orlando, FL (US)

(72) Inventors: Simone Pallotto, Etterbeek (BE); Anthony M. De Leo, Portage, MI (US)

(21) Appl. No.: 14/337,112

(22) Filed: Jul. 21, 2014

(51) Int. Cl. A47J 36/06; B65D 25/28; B65D 51/24; A47J 27/00

(52) U.S. Cl. CPC A47J 36/06; A47J 27/002; B65D 25/28; B65D 51/24; B65D 2525/283

(57) ABSTRACT

Cookware includes a lid having a handle with a utensil rest, and which is less messy than known devices. Utensil rest includes a utensil handle securing element which holds a utensil handle, and utensil rest likewise includes a utensil resting portion on which utensil handle and working end of the utensil may lie in a rest position. Utensil handle securing element may include a slot, which may extend lengthwise along the lid handle. Lid handle may include an upwardly extending region and an inwardly extending portion extending toward the center of the lid. The utensil rest portion may include a utensil handle rest element on a free end of inwardly extending portion, and a utensil working end rest element as well as a utensil handle securing element on upwardly extending region of utensil handle. Utensil rest may be used for spoons, forks, and knives of a variety of shapes.

### CROSS REFERENCE TO RELATED APPLICATIONS

This application is related to co-pending application Ser. Nos. 29/497,079; 29/497,080; and 29/497,081, which are incorporated by reference herein.

### STATEMENT REGARDING FEDERALLY SPONSORED RESEARCH

Not applicable.

### BACKGROUND OF THE INVENTION

The present invention relates in general to household cookware including a lid having a handle with a utensil rest, such as a spoon rest.

It is known to provide cookware with a handle and spoon rest. Problems with known cookware having spoon rests include that they are difficult to use, complicated, and the utensil may only rest in one position.

### SUMMARY OF THE INVENTION

An object of the present invention is to provide a lid with a handle which overcomes the drawbacks of the prior art.

Another object of the present invention is to provide a lid having a handle with a utensil rest which is easier to use than known lids, is versatile, and reduces the likelihood of a utensil in the utensil rest smearing or leaving food from the utensil on the lid, in use.

A further object of the present invention is to provide a lid having a handle and a utensil rest by which a user can rest a utensil in a number of rest positions.

Yet another object of the present invention is to provide a lid having a handle and a utensil rest as well as a utensil securing portion for securing a handle of utensil in one position and for resting a working end of the utensil and the handle of the utensil in a second position.

These and other objects are achieved by cookware according to the invention including a lid having a handle incorporating a utensil rest, and which is less messy than known devices. The utensil rest includes a utensil handle securing element which holds a utensil handle, and the utensil rest likewise includes a utensil resting portion on which the utensil handle and the working end (or head) of the utensil may lie in a rest position. The utensil handle securing element may include a slot, which may extend lengthwise along the lid handle. The lid handle may include an upwardly extending region and an inwardly extending portion extending away from the upwardly extending region toward the center of the lid. The utensil rest portion may include a utensil handle rest element on a free end of the inwardly extending portion, and a utensil working end rest element as well as a utensil handle securing element on the upwardly extending region of utensil handle.

### BRIEF DESCRIPTION OF THE DRAWINGS

The objects and features of the invention noted above are explained in more detail with reference to the drawings, in which like reference numerals denote like elements, and in which:

FIG. 1 is a top perspective view of the lid having a handle with a utensil rest according to the present invention;

FIG. 2 is a top plan view of the lid of FIG. 1;

FIG. 3 is an enlarged cross-sectional view along line 3-3 of FIG. 2;

FIG. 4 is a top perspective view of the lid having a handle with a utensil rest according to the invention, in use on a container; and

FIG. 5 is a top perspective view similar to FIG. 4 in a different use position.

### DETAILED DESCRIPTION OF THE INVENTION

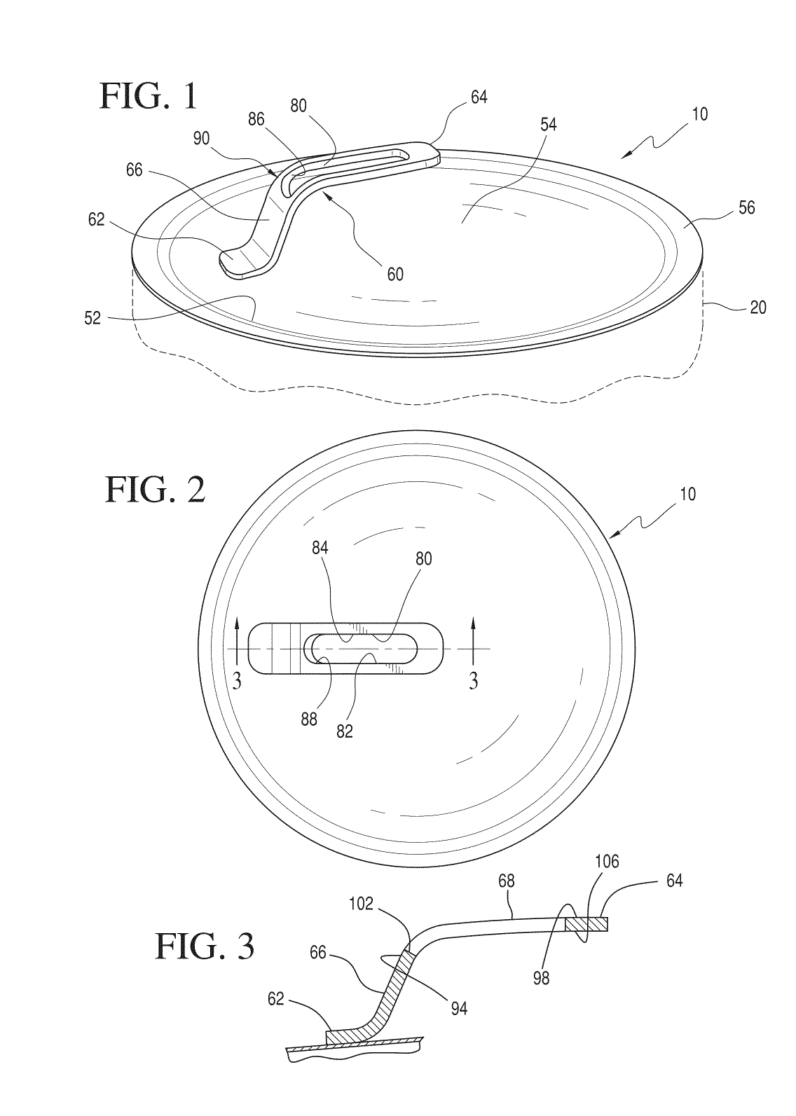

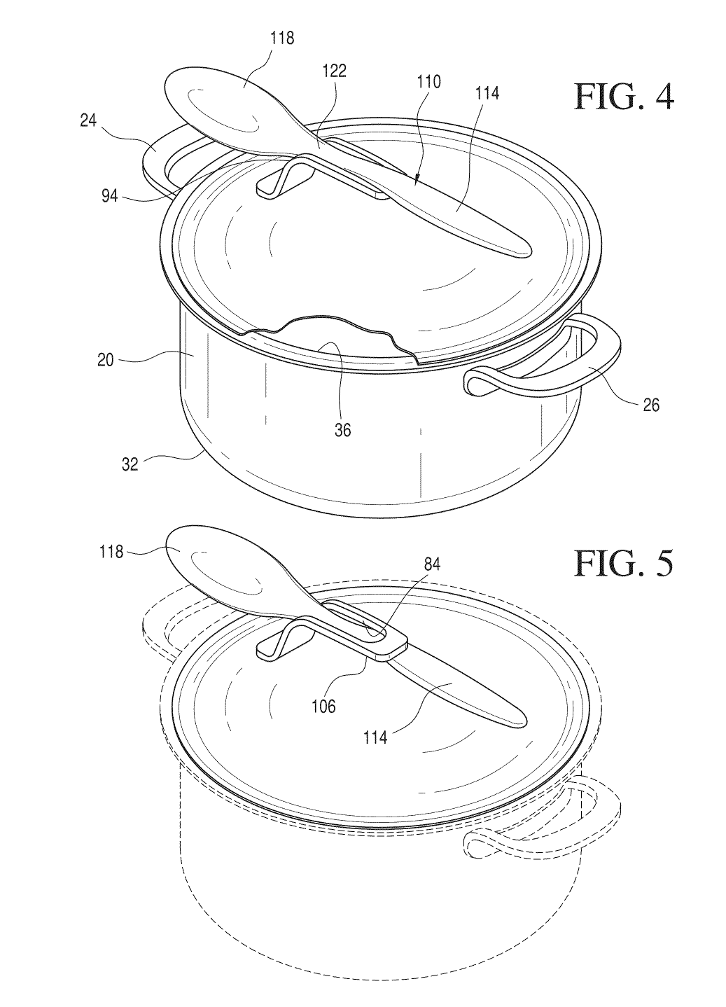

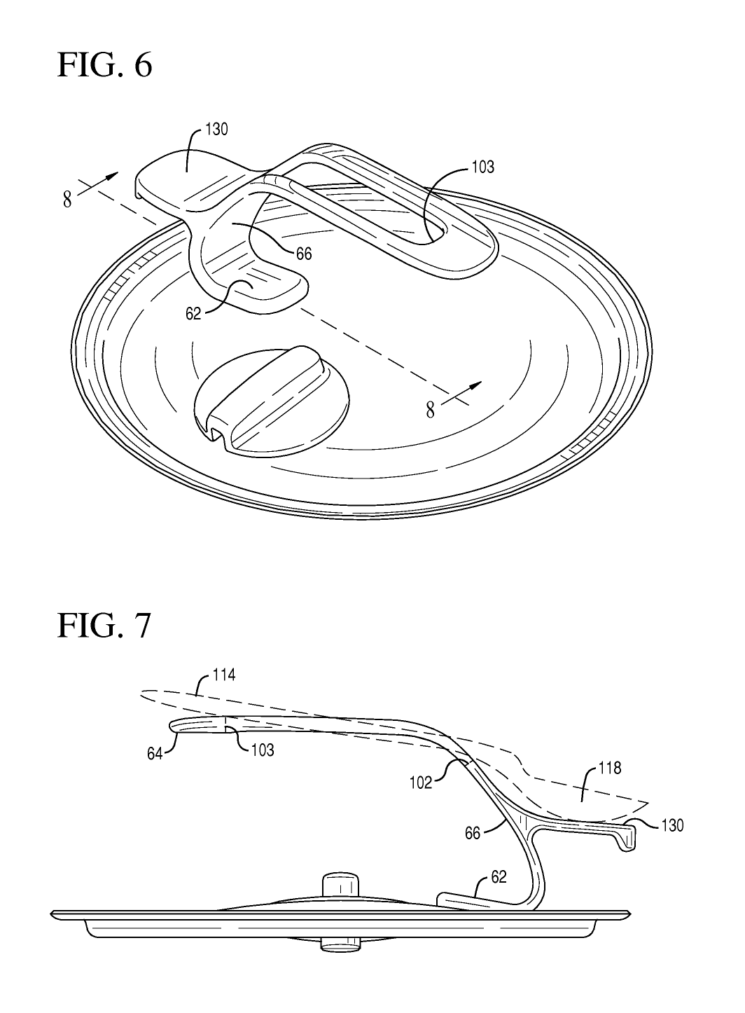

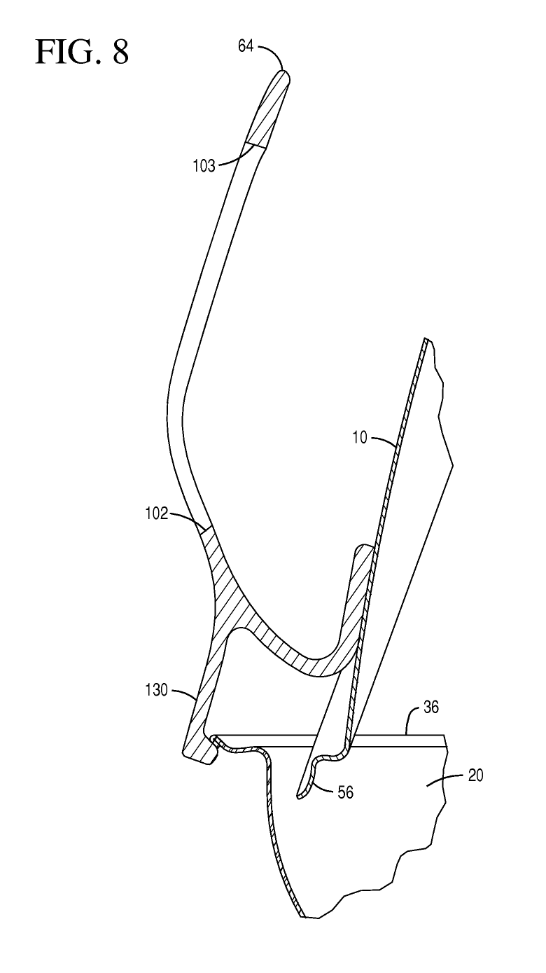

With reference to FIGS. 1-3, a cookware according to the invention includes a lid 10 for covering an open top of a container 20, such as a pot. For ease of discussion, reference is made to FIGS. 4 and 5 in which container 20 is shown having handles 24, 26, and an open end 36. Lid 10 may include an outer region 52 and an inner region 54. A lid handle 60 having a first end 62 and a second, free end 64 may be provided on lid 10. First end 62 may be attached, such as fixedly attached as shown, to outer region 52 of lid 10. First end 62 could of course alternatively be attached to the inner region 54.

Lid handle 60 may further include an upwardly extending region 66 and an inwardly extending portion 68 ending in free end 64. The inwardly extending portion 68 is of course not limited to extending inwardly from the outer region 52 toward the inner region 54, and portion 68 is named in this manner only for narrative convenience. Should the first end 62 be secured to the center of the lid 10, then the inwardly extending portion 68 would actually extend radially outward. This is encompassed within the present invention. A slot 80 including a first side 82 and a second, spaced apart side 84 may be provided in inwardly extending portion 68 and continue uninterrupted into upwardly extending region 66. Slot 80 may serve as a utensil handle securing element for holding a utensil handle of a utensil including a handle and a working end (or head). For example, slot 80 may include regions 86, 88, respectively, which hold or assist in holding a utensil handle depending on the configuration of the utensil handle being used. Use will be described in greater detail below with referenced to FIGS. 4 and 5. A utensil retaining and resting portion 90 may be provided. Utensil resting portion 90 may include a working end resting element 94 on which a working end, such as the bowl of a spoon, may rest when in a resting position. Utensil retaining and resting portion 90 may further include a utensil handle rest element 98 on which a utensil handle may rest in a further rest position, such as shown in FIG. 5 and detailed below. Utensil retaining and resting portion 90 may further include a utensil handle securing or engaging element 102 provided on upwardly extending region 66, as best seen in FIGS. 1-3. The engaging element 102 is formed by a first end of the slot 80, and the second end of slot 80 forms a rear engaging element 103.

Utensil handle securing or engaging element may be considered a part of slot 80, namely, the first and second sides 82 and 84 of slot 80, or the regions 86, 88 specifically. Depending on the shape of the utensil secured, the utensil handle may or may not engage the regions 86 and 88, when utensil is in the rest portion position of FIG. 4 in which the utensil handle may engage. Rather, there may be utensil handles which may be held with a retaining element 102 provides a portion of, or, indeed, the majority of the support for retaining the utensil handle.

As shown in the Figs., and as will be appreciated, it is preferred that the utensil rest on the handle according to the invention is configured for holding the working end 118 of utensil away from inner region 54 of lid 10. In that manner, when a user grasps handle 60 on inwardly extending portion 68, then the user grasps utensil handle 114 when picking up lid 10 by its handle 10. In that manner, the user's hand will not contact food which may be on working end 118 of the handle, in use.

It is contemplated that the configuration of the handle rest may be provided such that in one or both of the use positions of FIGS. 4 and 5, the working end 118 of the utensil is located at an opposite direction as shown; i.e., located substantially above inner region 54 of the lid.

Further, as shown in the different use positions of FIGS. 4 and 5, a utensil 110 having a handle 114 and a working end 118 may rest on handle 60, as shown. FIG. 4 shows a first use position in which utensil handle 114 rests on utensil handle rest element 98 and working end 118 rests on working end resting element 94. As will be readily understood, the point at which utensil 110 rests on handle 60 may be in a transition region 122 of utensil 110 located between handle 114 and working end 118. In the use position of FIG. 4, a portion of working end 118 or of transition region 122 will rest on working end resting element 94.

A further use position is shown in FIG. 5 in which utensil handle 114 engages one or more of utensil handle engaging element 102, and first and second regions 86 and 88 of slot 80. As shown in FIG. 5, in the case of the illustrated utensil 110, utensil 110 contacts handle 60 in the regions of engaging element 102 and regions 86 and 88 of slot 80. Utensil handle 114 does not contact a further utensil handle engaging region 106, as shown. This may be appreciated by considering the unnumbered space or gap located between utensil handle 114 and side 84 of slot 80. If a different utensil were in use, its handle 114 might contact engaging element 106, as will be readily understood. More particularly, the engaging element 102 would act as a balance point for the handle 114, with the weight of the working end 118 causing the utensil to rotate the working end downward, but the abutment of the utensil handle 114 against the engaging region 106 preventing such rotation.

A further embodiment of the lid handle is shown in FIGS. 6-8. In this embodiment the lid handle 60 further includes a head rest 130 in the form of a platform extending from the upwardly extending region 66 at a position spaced below the utensil handle engaging element 102. The head rest 130 ends in a free end. As best illustrated in FIG. 7, the utensil working end (or head) 118 may rest upon the head rest 130, with a portion of the utensil handle 114 received within the slot 80 to prevent lateral displacement. The utensil handle 114 will further rest upon one or both of the element 102 or 103. The utensil will thus be securely held against accidental or unintended movement, yet will be readily available for use. Further, as with the other two descriptions of use, the user could lift the lid 10 using the lid handle 60 while the utensil 110 is resting on the lid handle 60.

In a further improvement, the free end of the head rest 130 further includes a downward extending hook 140. As best illustrated in FIG. 8, the lid 10 may be partially received within and rest upon the open end 36 of the pot, with the hook 140 engaging the outer portion of the open end to thus hold the lid 10 in a generally upright position allowing access to the pot without having to hold the lid 10.

It is further contemplated that lid 10 may be provided in combination with container 20, and lid 10 and container 20 have been sized and configured so that lid 10 mates with and closes open end 36 of container 20.

From the foregoing it will be seen that this invention is one well adapted to attain all ends and objects set forth above together with the other advantages which are inherent within its structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth of shown in the accompanying drawings is to be interpreted as illustrative, and not in a limiting sense.

1. A cookware, comprising:
a lid for covering an open top of a container;
a handle provided on said lid, said lid handle comprising a first end attached to the lid and a second, free end;
said lid handle having a utensil rest portion;
said utensil rest portion having a utensil handle securing element for holding a utensil handle of a utensil having the utensil handle and a working end;
said utensil rest having a utensil handle rest element on a top face of said lid handle; and
said utensil rest having a utensil working end rest element on said lid handle.

2. Cookware as in claim 1, wherein:
said utensil handle securing element in said lid handle includes a slot.

3. Cookware as in claim 2, wherein:
said first end of said lid handle is attached to an outer region of said lid and extends away from said outer region toward the center of said lid; and
said slot extends lengthwise along said lid handle.

4. Cookware as in claim 2, wherein:
said slot includes a first side and a second side spaced apart from said first side, and said first and second sides engaging a utensil handle placed in said slot.

5. Cookware as in claim 1, wherein:
said lid handle includes an upwardly extending region and an inwardly extending portion extending away from said upwardly extending region toward the center of said lid and ending in a free end;
said utensil handle rest element is on said free end; and
said utensil working end rest element is on said upwardly extending portion.

6. Cookware as in claim 5, wherein:
said utensil handle securing element is adjacent said utensil working end rest element.

7. Cookware as in claim 1, wherein:
a container having an open top is provided; and
said lid is sized for covering said open top.
